(19) United States
(12) Patent Application Publication
(10) Pub. No.: US 2013/0091023 A1
(43) Pub. Date: Apr. 11, 2013

(54) METHOD FOR AUTOMATICALLY VISUALIZING AND DESCRIBING THE LOGIC OF A VARIABLE-DATA CAMPAIGN

(71) Applicants: Michael David Shepherd, Ontario, NY (US); Kirk J. Ocke, Ontario, NY (US); Dale Ellen Gaucas, Penfield, NY (US); Barry Glynn Gombert, Rochester, NY (US)

(72) Inventors: Michael David Shepherd, Ontario, NY (US); Kirk J. Ocke, Ontario, NY (US); Dale Ellen Gaucas, Penfield, NY (US); Barry Glynn Gombert, Rochester, NY (US)

(73) Assignee: XEROX CORPORATION, Norwalk, CT (US)

(21) Appl. No.: 13/253,999

(22) Filed: Oct. 6, 2011

(51) Int. Cl. G06Q 30/02

(52) U.S. Cl. 705/14.72

(57) ABSTRACT

As set forth herein, computer-implemented methods and systems facilitate providing an approach for using defined patterns of variable-data campaigns to enable a marketing service provider to express a non-expert user's desired campaign intent, using natural language and campaign intent terms, as well as to accurately capture the non-expert user's intent by communicating using non-technical campaign terminology. Communication of semantically robust campaign intent to variable-data campaign graphic designers and developers is facilitated by the described systems and methods, as is automated creation of a variable-data logic (plan) file based on semantic campaign intent. The described systems and methods facilitate the creation of variable data publishing (VDP) marketing campaigns by the non-expert, including verification and validation of the variable-data logic.

### TECHNICAL FIELD

The presently disclosed embodiments are directed toward methods and systems for generating a marketing campaign. More particularly, the teachings disclosed herein are applicable to methods and apparatuses for automatically visualizing and describing the logic of a variable-data campaign. It will be appreciated that the described systems and methods may find application in other fields.

### BACKGROUND

Data suggests that somewhere between 30-40% of marketing campaigns are personalized, most of which only vary content based on the recipient's name. First-name and last-name are simple textual data values that can be leveraged in a limited capacity on a personalized document (e.g., embedded in textual message or in an image). As CRM (customer relations management) systems become more sophisticated, much more data becomes available in which campaigns can be personalized for customers or prospects. The data (e.g. first-name, last-name, age, gender) and logic (a.k.a “business rules”—e.g. “if gender is male and age is less than 30, then special offer=iPhone otherwise special offer=Blackberry) aspects of a variable data publishing (VDP) plan creation are difficult and time consuming. Marketing Service Providers (MSPs) invest large amounts of time understanding the desires of the campaign customer, testing the specific campaign requirements, and creating the logic necessary to fulfill the campaign intent.

There is a need in the art for systems and methods that facilitate identifying the intent of a user/campaign creator designing a marketing campaign while overcoming the aforementioned deficiencies. In addition, when the user/campaign creator does not have an expertise in logic programming, as may be the case of the marketing service professional (MSP) or small-medium business (SMB) owner, there is a need for easy verification and validation of the variable-data logic is desirable.

### BRIEF DESCRIPTION

In one aspect, a computer-implemented method for personalizing a variable data publishing (VDP) marketing campaign pattern, comprises receiving user input related to an intended campaign purpose from a non-expert user, automatically selecting a VDP pattern from a plurality of a pre-generated VDP patterns as a function of the intended campaign purpose, retrieving product information to be presented on campaign documents for distribution to a plurality of recipients, receiving recipient information to appear on the campaign documents, prompting the user, as a function of the intended campaign purpose, to specify personalization parameters for personalizing the campaign documents, receiving user-specified personalization parameter information, outputting a personalized VDP pattern instance for use in generating the campaign documents, displaying a representative illustration of at least one campaign document including at least one dynamic content object based on at least one of the product information and recipient information, and displaying a natural language description of at least one dynamic content object.

The receiving user input related to an intended campaign purpose can comprise presenting the user with a plurality of natural language sentences each describing a different campaign purpose, and receiving an indication from the user regarding a selected natural language sentence. The displaying a natural language description of the at least one dynamic content object includes displaying at least a portion of a selected natural language sentence. The method can include displaying a plurality of natural language descriptions.

The method can include presenting the user with at least one VDP element comprising a natural language sentence having a plurality of selectable element parameters, and/or receiving an indication that the user has selected at least one of the selectable element parameters. The selectable element parameters can comprise one or more of: a personalized product to be offered to the recipient, a personalized reward to be offered to the recipient, a restriction placed on a personalized offer made to the recipient, and a personalized call to action to be performed by the recipient. The recipient information can comprise a first name of each recipient, a last name of each recipient, an address of each recipient, and/or an amount of money spent by each recipient in a given time period for one or more products sold by the user.

A processor can be configured to execute computer-executable instructions for performing the methods set for above, the instructions being stored on a computer-readable medium.

In accordance with another aspect, a system that facilitates personalizing a variable data publishing (VDP) marketing campaign pattern, comprises a graphical user interface (GUI) via which a user interacts with a campaign creation application that is persistently stored on a computer-readable medium, and a processor that executes the campaign creation application and is configured to receive user input related to an intended campaign purpose from a non-expert user, automatically select a VDP pattern from a plurality of a pre-generated VDP pattern as a function of the intended campaign purpose, retrieve product information to be presented on campaign documents for distribution to a plurality of recipients, the product information being retrieved from a product data source provided by the user, receive recipient information to appear on the campaign documents, the recipient information being provided in a recipient data source provided by the user; prompt the user, as a function of the intended campaign purpose, to specify personalization parameters for personalizing the campaign documents, receive user-specified personalization parameter information, and output a personalized VDP pattern instance for use in generating the campaign documents, display a representative illustration of at least one campaign document including at least one dynamic content object based on at least one of the product information and recipient information, and display a natural language description of the at least one dynamic content object.

The user input related to an intended campaign purpose can comprise an indication that is received via the GUI from the user regarding a user-selected natural language sentence describing the intended campaign purpose. The displaying a natural language description of the at least one dynamic content object can include displaying at least a portion of a user-selected natural language sentence.

The processor can be further configured to present the user with at least one VDP element comprising a natural language sentence having a plurality of selectable element parameters, and/or to receive an indication that the user has selected at least one of the selectable element parameters. The recipient data source can be an electronic spreadsheet document that comprises information regarding customers of the user.

In accordance with another aspect, a computer-readable medium having persistently stored thereon computer-executable instructions for personalizing a variable data publishing (VDP) marketing campaign pattern, comprising instructions for: receiving user input related to an intended campaign purpose from a non-expert user, automatically selecting a VDP pattern from a plurality of a pre-generated VDP pattern as a function of the intended campaign purpose, retrieving product information to be presented on campaign documents for distribution to a plurality of recipients, receiving recipient information to appear on the campaign documents, prompting the user, as a function of the intended campaign purpose, to specify personalization parameters for personalizing the campaign documents, receiving user-specified personalization parameter information, outputting a personalized VDP pattern instance for use in generating the campaign documents, displaying a representative illustration of at least one campaign document including at least one dynamic content object based on at least one of the product information and recipient information, and displaying a natural language description of the at least one dynamic content object. The displaying a natural language description of the at least one dynamic content object can include displaying at least one specified personalization parameter adjacent the at least one dynamic content object.

### BRIEF DESCRIPTION OF THE DRAWINGS

FIG. 1 illustrates a method for identifying campaign designer intent in which a VDP non-expert user can express the desired VDP logic for a personalized marketing campaign.

FIG. 2 shows an example VDP Pattern called “Product Offer.”

FIG. 3 illustrates a plurality of examples of VDP patterns, such as may be employed in conjunction with various aspects described herein.

FIG. 4 illustrates a system that facilitates identifying user intent when generating a marketing campaign in order to infer an appropriate VDP pattern and populate the pattern with personalized information, in accordance with one or more aspects described herein.

FIG. 5 is a screenshot of an exemplary campaign document.

FIG. 6 shows a screenshot of an exemplary campaign creation wizard.

FIG. 7 illustrates another screenshot of the exemplary campaign creation wizard.

FIG. 8 is yet another screenshot of the exemplary campaign creation wizard.

FIG. 9 shows still another screenshot of the exemplary campaign creation wizard.

FIG. 10 illustrates another screenshot of the exemplary campaign creation wizard.

FIG. 11 is still yet another screenshot of the exemplary campaign creation wizard.

### DETAILED DESCRIPTION

The above-described problem is solved by providing a knowledge-assisted method in which a VDP (variable data printing/publishing) non-expert can express his or her desired VDP logic for a VDP campaign. The technique is supported by a knowledge-base (e.g., a database+entity logic) of common types of VDP campaigns. Through the semantic expression of VDP elements and logic, the MSP can more easily and accurately convey the desired campaign intent to the team members collaborating on the campaign. Additionally, the MSP can more accurately align the execution of the campaign as expected by the client, as the patterns provide a more natural nomenclature for expressing campaign intent. Expression of campaign intent can automatically be reified into an executable campaign plan and corresponding data schema.

Highly personalized marketing can be significantly more successful by making the most effective use of customer data for creating an exceptional personalized experience, whether acquiring new customers or retaining and up-selling existing customers. The potential complexity of personalization grows with the amount of data resources accessible by the MSP. Thereby the logic involved in driving a personalized campaign can become very complicated. Larger available data sources cause complexity to grow in two directions: first, the implicit knowledge that can be derived from the explicit data in the data source; and second, the number and quality of decisions needed to be made based on the implicit and explicit data in order to create the highly personalized document.

As CRM systems become more sophisticated, they will not only incorporate more customer static and historical data, but will also be able to learn much more about a customer or prospect via web queries, real-time data, and interaction with online social media, as well as targeting via psychographics. As more customer data, both explicit and implicit, becomes available, there will emerge a need to express the logic of a marketing campaign using more robust automated knowledge techniques. As a result, many campaigns may be prone to either ignoring marketing opportunities hidden in the data due to the complexity of mining the data (resulting in less-effective campaigns) or requiring highly skilled database programming experts (resulting in high campaign costs). The subject innovation provides systems and methods that facilitate meeting the above-described needs in order to take advantage of more complex data and to improve marketing campaign personalization.

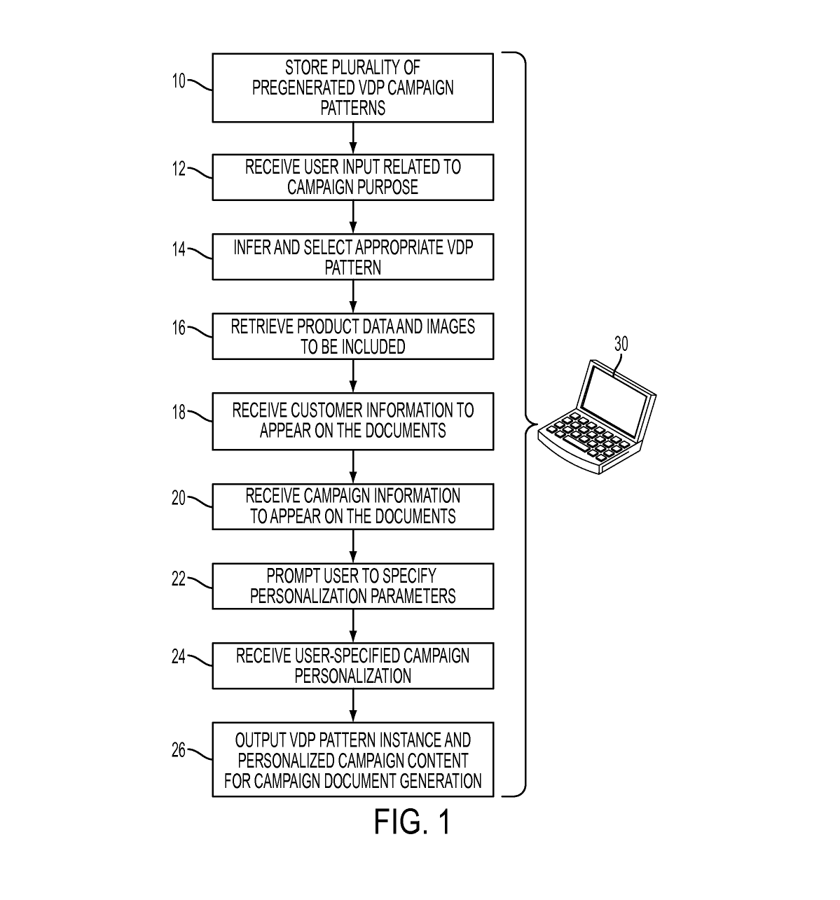

FIG. 1 illustrates a method for identifying campaign designer intent in which a VDP non-expert user, also referred to herein as a “campaign designer,” can express the desired VDP logic for a personalized marketing campaign. Accordingly, at 10, a plurality of pre-generated campaign patterns are stored (e.g., in a memory, computer-readable medium, etc.). These campaign patterns are hereafter referred to as “VDP Patterns.” Types of VDP Patterns include, without being limited to, Product Offer, Advertisement, Solicitation, Invitation, Announcement, Recall, Reminder, Survey, Greeting Card, Itinerary, etc. Additionally, each VDP Pattern is semantically defined and represented to contain VDP elements specific to that VDP Pattern. “VDP elements” denote high-level concepts that are typically populated by variable content. At 12, user input is received, which describes a campaign purpose (e.g., a sale, incentive, service, etc.). At 14, an appropriate VDP pattern is inferred based on the user's indicated campaign purpose and selected for populating with user-provided recipient-specific information. At 16, existing data and images to be used in the VDP pattern are received. The existing data and images can be entered (e.g., downloaded) by the campaign designer and/or can be selected from a database of stored images and/or data.

At 18, customer information to appear on the campaign documents is received. For instance, the designer can download or import customer data from a source, such as a spreadsheet or the like. At 20, campaign information to appear in the document(s) is received. Campaign information may include, for instance, a coupon or reward, a sale data and location, or any other information the designer wishes to disseminate to one or more customers. At 22, the user is prompted to specify personalization parameters for the campaign. User prompts are a function of the selected VDP pattern, which in turn has been selected as a function of the user's specified campaign intent. At 24, user-specified campaign personalization is performed. For instance, a user may wish to personalize the VDP pattern to include variable data such as name, nearest store to the named customer, and coupon size (e.g., which may be a function of an amount the named customer spent at the store in a previous time period or the like). At 26, the personalized VDP pattern and campaign content are output (e.g., on a graphical user interface, via a print-out, via email, or some other suitable means) for review and verification and for generating the campaign documents (e.g., personalized emails, post cards, mailers, web-based advertisements, etc.).

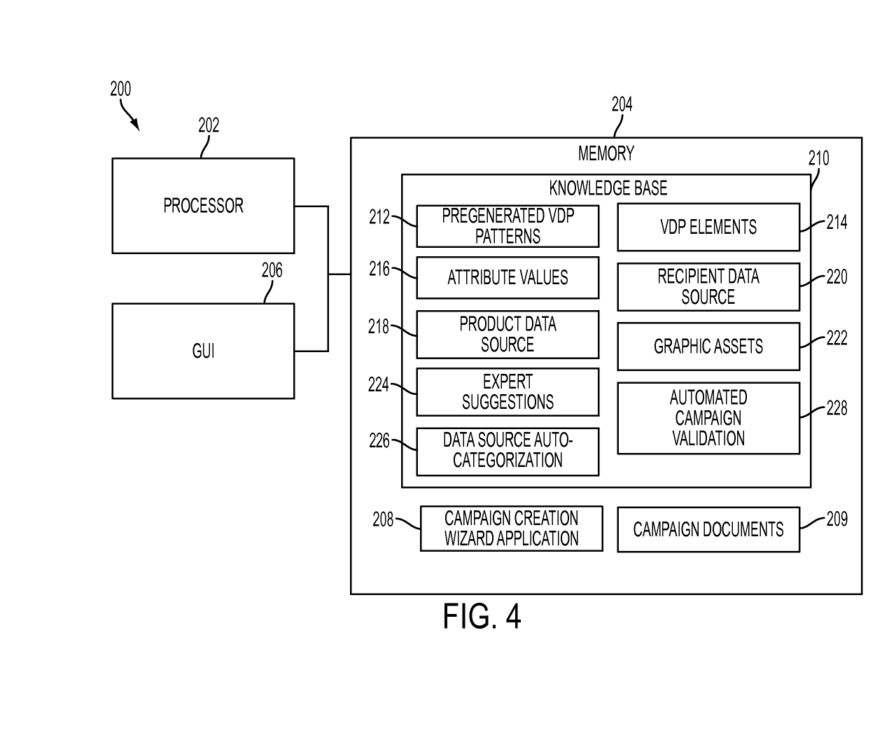

It will be appreciated that the method of FIG. 1 can be implemented by a computer 30, which comprises a processor (such as the processor 202 of FIG. 4) that executes, and a memory (such as the memory 204 of FIG. 4) that stores, computer-executable instructions for providing the various functions, etc., described herein.

The computer 30 can be employed as one possible hardware configuration to support the systems and methods described herein. It is to be appreciated that although a standalone architecture is illustrated, that any suitable computing environment can be employed in accordance with the present embodiments. For example, computing architectures including, but not limited to, stand alone, multiprocessor, distributed, client/server, minicomputer, mainframe, supercomputer, digital and analog can be employed in accordance with the present embodiment.

The computer 30 can include a processing unit (see, e.g., FIG. 4), a system memory (see, e.g., FIG. 4), and a system bus (not shown) that couples various system components including the system memory to the processing unit. The processing unit can be any of various commercially available processors. Dual microprocessors and other multi-processor architectures also can be used as the processing unit.

The computer 30 typically includes at least some form of computer readable media. Computer readable media can be any available media that can be accessed by the computer. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above can also be included within the scope of computer readable media.

A user may enter commands and information into the computer through an input device (not shown) such as a keyboard, a pointing device, such as a mouse, stylus, voice input, or graphical tablet. The computer 30 can operate in a networked environment using logical and/or physical connections to one or more remote computers, such as a remote computer(s). The logical connections depicted include a local area network (LAN) and a wide area network (WAN). Such networking environments are commonplace in offices, enterprise-wide computer networks, intranets and the Internet.

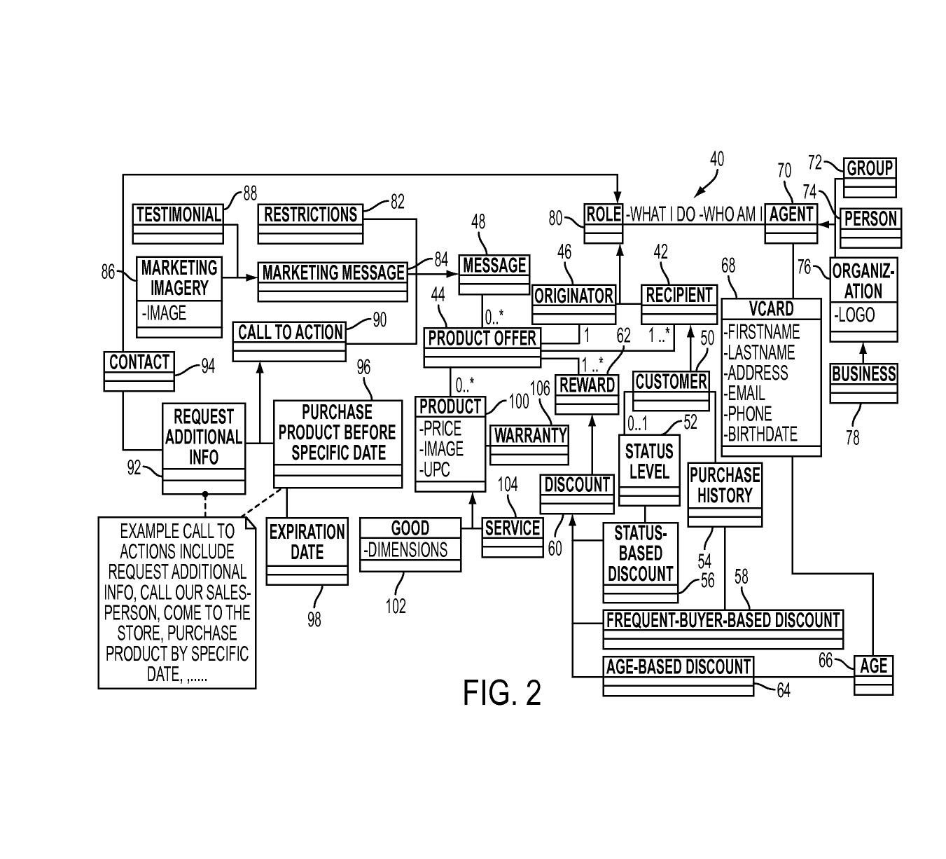

FIG. 2 shows an example VDP Pattern 40 called “Product Offer.” The surrounding boxes are the supporting VDP elements. “Element” as used herein denotes both a computer-readable medium or portion thereof that stores information, as well as a populatable and personalizable field into which the information may be entered by a user. For instance, a user may enter information into a given field presented to the user on a graphical user interface, and/or the information may be downloaded or extracted from an electronic document or source and automatically entered into appropriate fields. Once entered, the information is then stored at a predefined location in a system memory. Although the herein-described knowledge-base has in-depth knowledge of the relationships between elements, the system and method defined herein uses the VDP concepts most directly related to the specific VDP Pattern for illustrative purposes. Some VDP elements are shared across many VDP Patterns. For instance, every VDP Pattern, by the definition of VDP campaign, has a recipient element 42. As another example, Offers, Recalls, and Warranty Extensions typically all share the Product element 44. Different campaigns can use different VDP elements of the VDP Patterns. In one embodiment, some elements may be mandatory while others may be optional.

The VDP pattern 40 also includes an originator element 46 that originates the offer or marketing campaign, as well as a message element 48 that includes a message for the recipient. The recipient may be a customer of the campaign designer (e.g., a merchant), and therefore the pattern 40 includes a customer element 50. Each customer has a status level 52 and a purchase history 54, which can be analyzed to generate a status-based discount 56 and/or a frequent-buy-based discount 58. Information from the status-based discount element 56 and/or the frequent-buyer-based discount element 58 is provided to a discount element 60, which in turn provides information to a reward element 62 that generates a reward for inclusion in the product offer 44. An age-based discount element 64 can provide age-based discount information to the discount element 60. A customer's age 66 is stored or determined by an age element 66, such as by analyzing or storing a vcard 68 or the like.

The VDP pattern 40 also includes elements associated with an agent who can help the campaign designer design the marketing campaign. For instance, an agent element 70 comprises information regarding the identity of the agent, which may be collected from a group element 72 that identifies multiple agents, from a person element 74 that identifies a single agent, and/or from an organization element 76 that identifies an organization that acts as an agent. A business element 78 includes information related to the business of the organization acting as an agent. The agent element has is populated with a desired level of information describing the identity of the agent, and is associated with a role element 80 that includes information related to one of more functions or services provided by the agent.

The message element 48 can include one or more message types such as one or more restrictions on the product offer, which are stored in a restrictions element 82. The message may also include a marketing message that is stored in a marketing message element 84. The marketing message may include marketing imagery obtained from a marketing imagery element 86 that stores images, as well as testimonial information (i.e., testimonials for satisfied customers or the like) that are stored in a testimonial element 88. Additionally, the message 48 can include one or more calls to action that are stored in a call to action element 90. In one example, the call to action includes a request for additional information 92, in which case a contact element 94 is executed to contact either the recipient of the product offer or an agent (e.g., via the role element 80) who then contacts the recipient. In another example, the call to action includes an offer deadline, e.g., stored in a “purchase product before specific date” element 96. The deadline information for a given product offer is stored in an expiration date element 98.

The product offer 44 may also include product information, which is stored in a product element 100, and which may include, without limitation, one or more of product price, an image of the product, UPC information for the product, etc. A good element 102 includes product information for one or more goods, such as dimension and the like, while a service element 104 includes information related to a service that is to be offered. A warranty element 106 includes information related to product warranty, which can be included in the product offer 44.

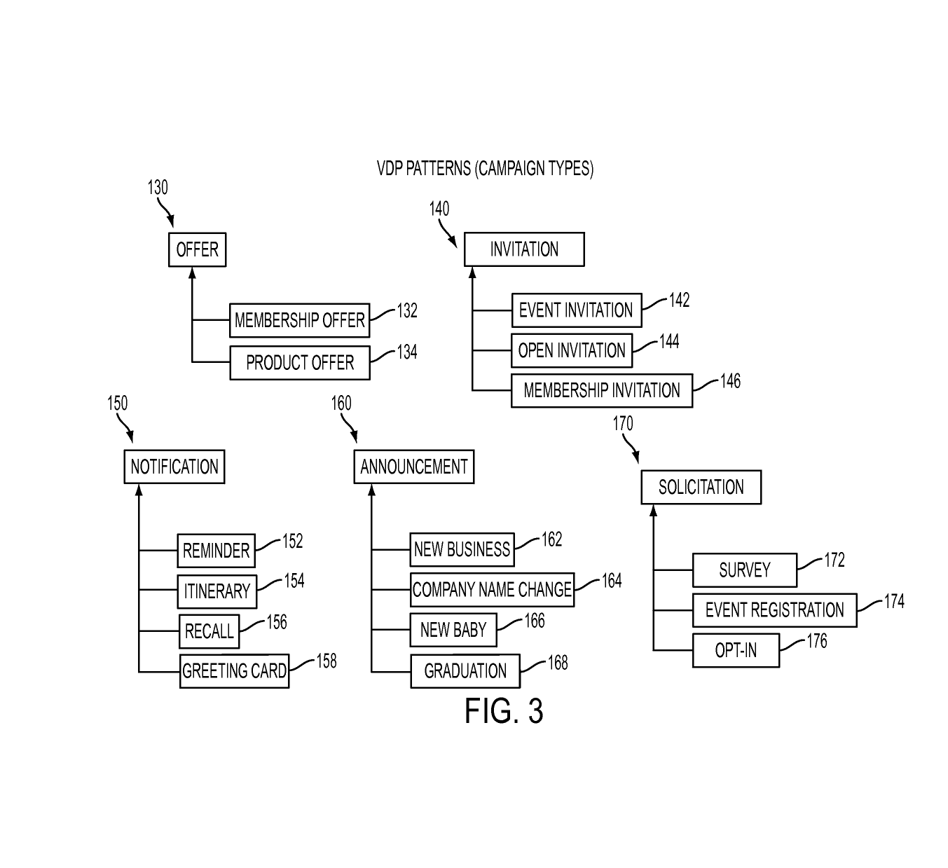

FIG. 3 illustrates a plurality of examples of VDP patterns, such as may be employed in conjunction with various aspects described herein. An offer VDP pattern 130 can include, for example, a membership offer 132 and/or a product offer 134. An invitation VDP pattern 140 can include, for example, an event invitation 142, an open invitation 144, and/or a membership invitation 146. A notification VDP pattern 150 may include, for example, a reminder 152, an itinerary 154, a product recall 156, and/or a greeting card 158. An announcement VDP pattern 160 can include, for example, a new business announcement 162, a company name change announcement 164, a new baby announcement 166, and/or a graduation announcement 168. A solicitation VDP pattern 170 can include, for example, a survey 172, an event registration form 174, and/or an opt-in form 176.

FIG. 4 illustrates a system 200 that facilitates identifying user intent when generating a marketing campaign in order to infer an appropriate VDP pattern and populate the pattern with personalized information, in accordance with one or more aspects described herein. The system comprises a processor 202 that executes, and a memory 204 that stores computer-executable instructions for performing the various functions, methods, techniques, steps, and the like described herein. The processor 202 and memory 204 may be integral to each other or remote but operably coupled to each other. In another embodiment, the processor and memory reside in a computer (e.g., the computer 30 of FIG. 1). The system further comprises a GUI 206 via which information is presented to the non-expert user (i.e., a layman marketing campaign designer, such as a store or small business owner or the like), and via which the user enters information to the system. The GUI 206 may also be integral to the computer 30.

The memory persistently stores data and computer-executable instructions for performing the described functions, methods, techniques, and the like. For instance, the memory 208 stores a campaign creation wizard module that is executed by the processor to receive information from the user, analyze received information, and output the business logic for a marketing campaign for to the user. In this manner, the wizard module 208 walks the non-expert user through the campaign design process in order to generate the business logic for the marketing campaign that targets the user's customers with personalized campaign documents 209 (e.g., post cards, mailers, emails, web-based ads, or any other suitable campaign media.

As stated above, the system 200 comprises the processor 202 that executes, and the memory 204 that stores one or more computer-executable modules (e.g., programs, computer-executable instructions, etc.) for performing the various functions, methods, procedures, etc., described herein. Additionally, “module,” as used herein, denotes a set of computer-executable instructions, software code, program, routine, or other computer-executable means for performing the described function, or the like, as will be understood by those of skill in the art. Additionally, or alternatively, one or more of the functions described with regard to the modules herein may be performed manually.

The memory may be a computer-readable medium on which a control program is stored, such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, RAM, ROM, PROM, EPROM, FLASH-EPROM, variants thereof, other memory chip or cartridge, or any other tangible medium from which the processor can read and execute. In this context, the systems described herein may be implemented on or as one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphical card CPU (GPU), or PAL, or the like.

A knowledge-base 210 (i.e., a computer-readable medium) of VDP patterns 212 is pre-constructed, e.g., by a knowledge engineer, and provided to such a system. The VDP patterns are represented using the vocabulary of the non-expert. Additionally, given a starting knowledge-base, the VDP patterns are also amenable to extension by the campaign designer (non-expert), graphic artist, VDP logic developer, or other campaign developer.

The systems and methods described herein are supported by the wizard module 208, which can accept the campaign designer's desired campaign intent and automatically express and store the campaign intent as one or more instances of VDP patterns 212 and VDP elements 214 (see, e.g., FIGS. 2 and 3). The described systems and methods use an underlying infrastructure to transform the provided instances into initial VDP plan logic that can be used by the logic developer to create the final VDP plan logic. The plan logic incorporates the rules, data schema, and content objects exported to the design. This arrangement also provides the logic developer and/or data specialist with a skeleton of the information expected to be available in the data, and as such can “flag” early on data inconsistencies or shortcomings. Sufficiently simple campaign plan logic could be used to compose the campaign documents without need for a logic developer.

The campaign designer first expresses (e.g., via the GUI 206) the type of VDP campaign they would like to create. This can occur in various ways. For instance, one approach is that all VDP patterns 212 stored in the knowledge-base 210 are presented to the campaign designer for them to choose from. To help select and instantiate a VDP pattern, the campaign designer may be presented with one or more examples in the form of a natural language (NL) sentence. The scope of the natural language used in this embodiment corresponds to the vocabulary of the VDP patterns, which represents the knowledge of the non-expert. Sentence examples may include, without limitation:
I want to send out a promotion to my new health club service.
I want to send out a recall notice for a specific tire model.
I want to send out notifications that a car warranty is expiring.
I want to send out (event) invitations to my family for a 50th wedding anniversary.
I want to up-sell my top customers by offering a variable discount on a new TV on their birthday.
I want to send out an announcement that my business is moving to a new location.
I want to send an (open) invitation for people to join my stamp collecting club.
I want to send out an advertisement to my customers announcing that we carry new finishing butters.
I want to send out customer satisfaction surveys to recent car repair clients.
I want to send personalized holiday greeting cards to all of my friends.

Each VDP pattern 212 is supported by a natural language description that consists of all high-level VDP elements 214 associated with that VDP pattern. The associated VDP elements are “parameterizable” pieces of the NL description. Some examples include:
Product Offer:
   For each recipient, my Product Offer will promote <Product> by offering <Reward> if the recipient takes <Call To Action>, with possible <Restrictions>.
Announcement:
   For each customer, my Announcement will convey new <Information> with the <Benefit> to the customer with a possible <Call To Action>
Event Invitation:
   My Event Invitation will invite each invitee to <Event> at designated <Venue> at a particular <Time> with a desired <Call To Action>, with possible <Restrictions>.

Each VDP element parameter (shown above in brackets <>) is provided as a semantic placeholder for the user to define VDP content. The campaign designer selects the VDP element from the sentence and may then enter any number of options to use as VDP content. For example, a pet store campaign designer selects the <Product> concept and inputs to the system the following product descriptions:
lams Hairball-Control Cat Food
Flexi Retractable Dog Leash
Habitrail Hamster Habitat
BioCube Aquarium

Each product description is automatically created as a product instance in the knowledge-base of VDP patterns. In cases where multiple values are entered, it is inferred that the VDP element “Product” is variable content, and that a rule is desirable to determine which specific product description to use for each recipient. The campaign designer is then requested to enter the semantics of the data source that will determine the variable content of product for a particular recipient. To further the present example, the campaign designer specifies “pet preference” and assigns data values “cat,” “dog,” “hamster,” and “fish,” respectively. The “Product” VDP element in this case is denoted as “variable” in the knowledge base and each instance of the Product is tagged with the data value that is used to select it as variable content.

The data value may be implicit or explicit, and may come from any number of sources. Examples of data value extraction sources include, without limitation: the value may come from a database expert who mines customer purchase history to determine “pet preference”; from a specific pre-existing data field available in a data source; or from automated techniques for determining available data implicit in a given data source.

Continuing the example, the campaign designer selects the <Reward> concept and is offered choices for the type of Reward such as a Frequent-Buyer-Based Discount. The designer may then choose to vary such a discount based on the amount of purchases (e.g., number of purchases, total amount spent on all purchases, etc.) for the past predetermined period (e.g., 12-months). Variable rewards are specified of e.g. “30%”, “20%”, and “10%” and are offered to customers who have specified “spend level” of values e.g. over $1000”, “between $500 and $1000”, and “less than $500” respectively. The Reward VDP element of Product Offer in the knowledge base is then denoted as “variable” and instantiated with these values, as was done for the Product VDP element above.

In a related example, the campaign designer wants the Call To Action element to be the same for all customers. The designer selects the <Call To Action> concept and enters a single value of “Redeem this offer at our store before June 30^{th}” The Call To Action VDP element in the knowledge base is set to “static” and instantiated with a single value. It will be appreciated that any VDP Pattern can be extended to include additional Promotional Messages, whether they are text or images. One option that the campaign designer may select is to include variable or static Promotional Messages in the VDP document. Continuing with the above pet store example, the campaign designer may provide various sets of graphic assets that they will use to provide an attractive marketing “feel” or aesthetic quality to the campaign document.

In some instances, the designer may desire to reuse the “pet preference” semantic data in which he desires to use imagery from a “cat” graphic asset folder or database when the pet preference is “cat”, a “dog” graphic asset folder when the pet preference is “dog,” etc. The graphic assets can also be pulled from a content management system that is connected to the wizard application. The designer can also specify variable text messages that include testimonials from cat-owners for the “cat” pet preference, testimonials from dog-owners for the “dog” pet preference, etc.

Once the knowledge base is populated with all desired instances that represent the campaign for a particular VDP pattern, the full instantiation of the campaign is then transformed into a partially-populated or, in some cases, a fully-executable, VDP plan. The transformation automatically creates all the content objects, the logic for determining the variable content, and the data schema needed to support the campaign plan, as well as stores the graphic asset files so they are accessible by the VDP environment. In a specific example in which Xerox's XMPie™ suite is employed, this feature creates an XMPie plan file for the uPlan™ logic definition application.

The VDP elements in the knowledge base may also contain various attributes 216 specific to a given element. For instance, a Product element may have single- and multi-valued attributes such as “price,” “image,” universal product code or “UPC,” etc. In one embodiment, a means for the campaign designer to specify values for the attributes of a VDP element is provided. The attribute values for the element are then made available as content when the corresponding VDP element is selected for a particular dynamic document. In one embodiment, the campaign designer downloads or otherwise generates a product data source 218 (e.g., a list, spreadsheet, or other data source comprising information relating to the products to be included on the campaign documents).

For instance, as the campaign designer is inputting the <Products> for the pet store campaign, he can specify a price and an image of each Product that is to appear on the marketing documents. In one example, upon entering the Product description, the campaign designer indicates a price and image that the product (e.g., a hamster habitat) will have, as associated attribute values. When providing associated values, known values are encoded directly into the knowledge base associated with the <Product> instance. Additionally or alternatively, an attribute value lookup is performed to identify the associated attribute value(s). In another embodiment, the associated value is initially left blank for later value assignment. A VDP element's attributes list may be obtained through various means with the GUI. Entries are made in the knowledge base that capture the campaign intent that the selected attributes represent variable content, as well as whether the selected attributes are graphics or text.

Continuing with the example, the campaign designer specifies known <Product> attribute values using the methods described herein. Table 1 shows examples of product attribute values 216, such as can be extracted from the product data source 218 by the processor 202 when executing the wizard 208, and/or entered directly by the campaign designer.

TABLE 1

| Product | Price | Image | UPC |
|---|---|---|---|
| Hairball Control | $30 | Image1.jpeg | 019014230079 |
| Food | | | |
| Retractable Dog | $20 | Image2.TIFF | 047181025019 |
| Leash | | | |
| Hamster Habitat | $25 | Image3.GIF | 080605626003 |
| Aquarium | $80 | Image4.PNG | 797926820514 |

The wizard 208 employs campaign intent that may include references to images. It will be appreciated by those of skill that any suitable image type or format may be employed by the subject systems and methods. While Table 1 illustrates four image file formats (jpeg, TIFF, GIF, and PNG), it will be understood that the herein-described systems are not limited thereto.

If the campaign designer desires the recipient's first name to appear on the dynamic document, then the designer indicates that they want the ‘firstName’ of the recipient to be variable and designate the assignment be to set up by a data specialist. The data specialist and/or logic developer then use this designer-specified campaign intent knowledge to modify the automatically created plan file to extract the appropriate value for the recipient's first name out of a recipient data source 220, which may be provided by the designer (e.g., a spreadsheet comprising a list of the designer's customers or a subset thereof, a database, a comma-delimited list of customers, etc.).

The knowledge base 210 also includes graphic assets 222 (e.g., images, icons, logos, etc.), that the user can select to personalize the campaign documents. Additionally, the expert suggestions are stored in the knowledge base and can be retrieved and presented to the user when the wizard determines that the user's VDP pattern can benefit from automatic suggestions of meaningful actions for the user to take. Additionally, the knowledge base 210 includes a data source auto-categorization module 226 that automatically determines the semantic categories of the data values (e.g., first name, last name, zip code, spend level, pet type, etc.) in each column or row of a downloaded data source. An example of a data source auto-categorization technique that may be employed in conjunction with various aspects described herein is found in U.S. patent application Ser. No. 12/857,997, filed on Aug. 17, 2010 and entitled “Semantic Classification of Variable Data Campaign Information,” which is hereby incorporated by reference herein in its entirety. An automated campaign validation module 228 continuously or periodically checks the campaign pattern during the design states for errors. If an error is detected, the wizard application prompts the user to correct the errors and walk the user through the corrective actions.

As will be appreciated, personalized campaigns are accomplished through the use of dynamic documents, each of which contains content that is specific and relevant to a particular recipient. The data that drives the dynamic content not only can originate from a recipient data source which contains information about all potential recipients of the campaign, but also from auxiliary non-recipient data sources that contain information not specific to the individual recipients. Examples of non-recipient data sources include data sources describing products, cities, countries, organizations, venues, events, vehicles, etc.

Campaign designers will formulate requirements for variable-data marketing campaigns that include the particular categories of data which they desire to use as the dynamic content in the VDP campaign. These categories of data can include both recipient data and, as noted, non-recipient data. Often times the campaign designer will desire to render information on the dynamic document that is not readily accessible via a data source they have on hand, or their data source may be missing the desired information. In such cases, the system 200 and/or wizard 208 can be configured to access information from other sources to facilitate the creation of a desired data source for a VDP campaign.

One potential source of information are Encyclopedic Knowledge-Bases (EKB). EKBs semantically capture a wide expanse of knowledge through the use of Linked Data and ontological representations. Semantic mark-up of sites such as Wikipedia provide specific references to content which can be linked together into a Resource Description Framework (RDF) Data Model to provide a web of Linked Data. Additionally, ontologies provide a structured knowledge framework to semantically convey certain meanings on the relationships in the Linked Data. These ontologies include DBpedia (RDF of Wikipedia), GoodRelations (RDF of commercial details of Business Offering), eClassOWL (RDF of type and features of products or services), Consumer Electronics Ontology, FOAF (RDF of social networks), etc.

Queries about particular entities can be posed to EKBs which return a vast set of information about the entity's types, properties, and relationships with other entities. This can be accomplished through the use of an RDF query language called SPARQL, for example.

As described above, the campaign designer may desire to render non-recipient data on the VDP campaign's dynamic documents. The campaign designer expresses a requirement (or campaign intent) to select data about a particular entity. This can be done in the context of a campaign brief, via a new VDP Pattern Element as described in commonly assigned U.S. patent application Ser. No. 13/211,437 filed on Aug. 17, 2011, (Atty Docket No. 20100239-US-NP/XERZ 202535US01XERZ202535us01), which is hereby incorporated by reference in its entirety, or through discussion with a VDP data expert.

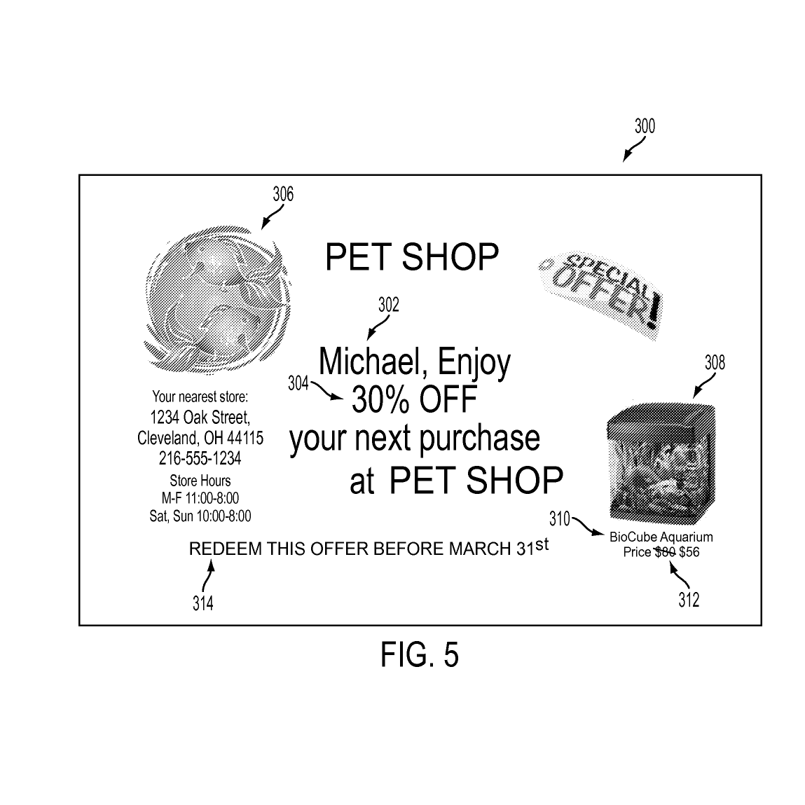

With continued reference to the preceding FIGURES, FIG. 5 shows a screenshot of an example advertisement 300 or offer that is presented to a recipient by a pet store merchant or proprietor. Variable data (e.g., recipient names, spend levels, pet preference, pet names, etc.), is extracted from a recipient data source such as a spread sheet or the like maintained by the merchant or proprietor offering the product. An example of a recipient data source, such as the recipient data source 220 of FIG. 4, is shown in Table 2.

TABLE 2

| | | | Customer | Customer | | |
|---|---|---|---|---|---|---|
| | First | Last | Spend | Pet | Customer | Zip |
| ID | Name | Name | Level | Preference | Pet Name | Code |
| 1 | Michael | Shepherd | 720 | fish | | 10005 |
| 2 | Kirk | Ocke | 260 | dog | | 90212 |
| 3 | Dale | Gaucas | 405 | cat | | 60622 |
| 4 | Lee | Moore | 210 | hamster | Cotton | 60625 |
| 5 | Barry | Gombert | 450 | bird | | 10011 |
| 6 | Karen | Braun | 660 | dog | Fido | 91230 |
| 7 | Al | Coté | 850 | fish | | 60623 |
| 8 | Mike | Kehoe | 65 | bird | | 90210 |
| 9 | Mohit | Seth | 155 | hamster | | 10018 |

The ad 300 includes several variable data fields that have been populated using the described wizard application. For instance, a recipient's name 302 is personalized, and a personalized discount 304 is also presented in the advertisement. In the illustrated example, the first recipient has a first name of “Michael,” has a pet fish, and has a high spend level relative to other recipients in the data source. Since it is known from data provided by the marketing campaign designer (i.e., the merchant or proprietor of the store, or the like) that the particular recipient keeps pet fish, a pet image 306 of goldfish is included in the personalized advertisement. Additionally, since the recipient is known to have a pet fish, an aquarium is selected as a potential product for sale, and an image 308 of the product is presented on the ad 300. The product name 310 is also presented, along with the product price 312 (the discounted price and the original price, which is also variable as a function of the given recipient's spend level, customer status level, etc.)

In one example, the product data source includes information related to product identity and price, as shown in Table 3.

TABLE 3

| Product | | | |
|---|---|---|---|
| Name | Product Price | Product Quantity | Customer Rating |
| Iams Cat | $26 | 45 | 4.8 stars |
| Food | | | |
| Flexi Dog | $15 | 63 | 4.5 stars |
| Leash | | | |
| Habitrail | $50 | 12 | 4.3 stars |
| Habitat | | | |
| BioCube | $80 | 8 | 4.5 stars |
| Aquarium | | | |
| Nutriphase | $19 | 22 | 4.1 stars |
| Bird Food | | | |

The system thus applies the discount (i.e., 30% in the example of FIG. 5), which is variable as a function of the particular recipient, to the original price (i.e., $80) to calculate the discounted price (i.e., $56 in this example), which is also presented in the advertisement. Additionally, the advertisement includes a call to action 314 in the form of an “purchase-before” date (e.g., an expiration date for the offer).

As will be appreciated, highly personalized marketing can be significantly more successful by making the most effective use of customer data for creating an exceptional personalized experience, whether acquiring new customers or retaining and up-selling existing customers. The potential complexity of personalization grows with the amount of data resources accessible by the marketing service professional (MSP). Accordingly, the logic (business rules) necessary to drive a personalized campaign can become very complicated and, in some instances, may become so complex that it is difficult to determine why particular data (e.g., dynamic content objects) is included in the campaign documents.

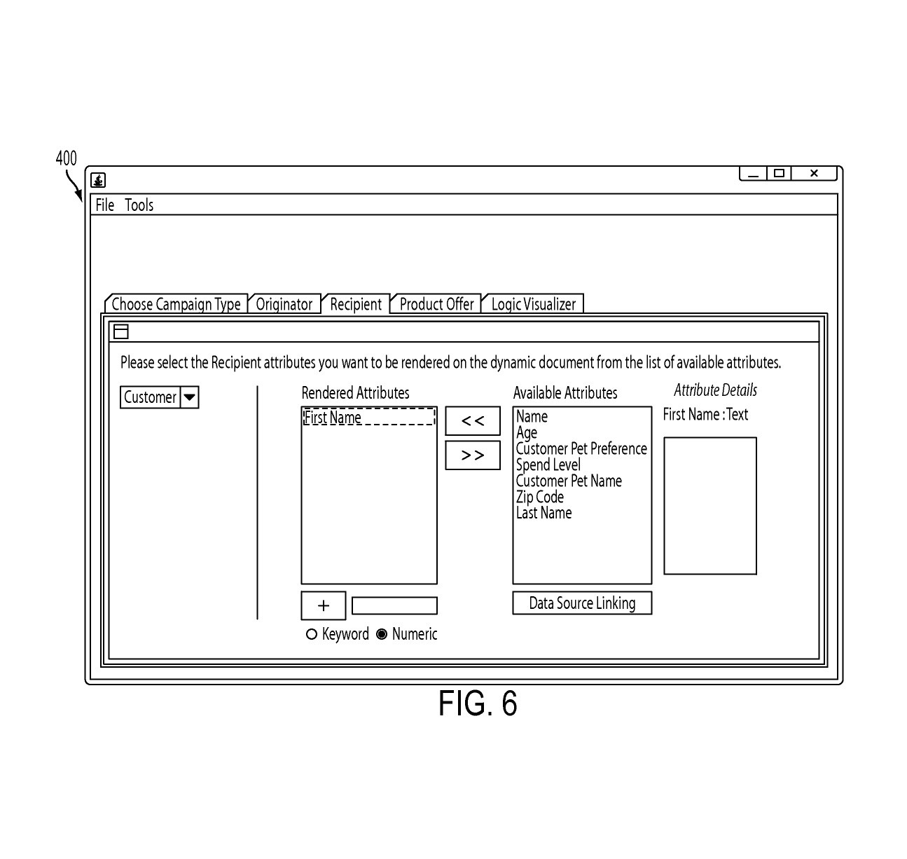

Turning to FIGS. 6-11, exemplary screen shots are illustrated that show, among other things, a method in which VDP plan logic for a marketing campaign can be visualized and meaningfully described to a creator or client of the campaign. A semantically descriptive VDP plan, such as generated by the system described above, is populated with dynamic content objects representing the document content which will vary for each campaign Recipient. The method described herein analyzes the dynamic content objects and generates a natural-language description for each dynamic content object specified. Upon execution of the VDP plan logic to render a proof set of the dynamic documents, each description is customized on each dynamic document to convey to the creator and/or client how the dynamic content was selected to be rendered by the plan logic.

As the logic is being developed throughout the creation process, it is useful to be able to visualize the results of the logic as it is being created. This approach can differ from soft proofing a document in a number of ways. For example, the visualization i) can be dynamically displayed as the logic creation application is used to define the variable-data business rules, ii) may be only of the rendered content derived from the business rules, iii) does not need to include elements of the campaign's graphic design and layout, iv) may be annotated with informative descriptions to assist in semantic understanding the business rules, v) is independent of delivery channel (print, web, e-mail, SMS, etc.)

Semantically meaningful variable-data logic can be used to glean useful annotations that can subsequently supplement the visualization. Through the use of a semantically-aware campaign creation application, such as the one described above, an MSP or SMB can provide their campaign intent and use it to auto-generate the VDP logic for the campaign. The application allows the MSP/SMB to semantically describe their campaign intent using their own vocabulary. The resulting logic plan file content then consists of the user's semantic vocabulary which is incorporated into the visualization and related annotations.

When initially creating a campaign, the user specifies a Recipient data source. This data source provides the recipient data which cause the appropriate variable content to be rendered on the dynamic document. As the user creates the campaign, they specify how to use the recipient data to populate the variable content. There are two typical ways to determine the variable content:
Directly—the recipient data is directly rendered onto the dynamic document (such as first name, last name, home address, etc.)
Indirectly—the recipient data is used to derive related content in which to render (such as a recipient's Zip Code may determine a Date for an event, or a recipient's Previous Spending may determine the level of Discount to offer them).

Per the method of the present disclosure, as each piece of variable content is defined by the user, the application used to build the logic automatically packages the current state of the variable-data logic, the recipient data source, and an appropriate layout template*, and submits to a variable-data processing server (such as XMPie uProduce) to render a set of dynamic documents. These dynamic documents are reflected back to the user of the logic application (via web page, image viewer, or other means) for user review of the results of the logic that was specified. In the illustrated examples, the layout templates are simple and sufficient to display the results of the variable content. The templates may be dynamically constructed based on the number of variable content items, or be pre-constructed for a basic linear layout. These layout templates need not incorporate any aesthetic design beyond the ability for the user to distinctly view each piece of variable content.

The user can also choose to view annotations of the variable content which describe in a semantically meaningful way why each of the variable content pieces contains the result shown in the dynamic document. These annotations may be viewed by the user in any number of ways, including:
Variable content and their annotations are automatically separated into XMPie “visibility layers” where the layers can be turned ‘on’ or ‘off’ to display only the variable content, only the annotations, or both together.
Annotations are automatically created by adding additional logic to the plan file such that each piece of variable content has a ‘business rule’ to create both the original variable content and its corresponding annotation. A layout template is used to place the corresponding annotation in proximity to the original variable content. (This approach is shown in the example below.)
Annotations are automatically written into a PDF as ‘comments’ (via a PDF SDK) or into a web page as ‘pop-up tool tips’ (via a Web SDK) that correspond to each piece of variable content. The corresponding annotation appears as the variable content is hovered over or clicked upon.

Subsequently, through the use of an interactive viewer (such as XMPie's uEdit), the dynamic document results could also be integrated into such a viewer application which allows the campaign creator to modify the positions of the variable-data content objects to be more appealing to them and provide a graphic artist a rough rendition of the document layout which is desired.

### EXAMPLE 1

An example scenario is provided below which iteratively employs the method described herein as a campaign designer creates the campaign business rules and gets visual feedback. A campaign designer for a Pet Store has the following idea (see FIG. 5) for a Product Offer marketing campaign to offer a variable discount (based on customer spending history) on a variable product (based on a customer pet preference of cat, dog, hamster, or fish). The user specifies a Recipient data source for the campaign, such as Table 2 above.

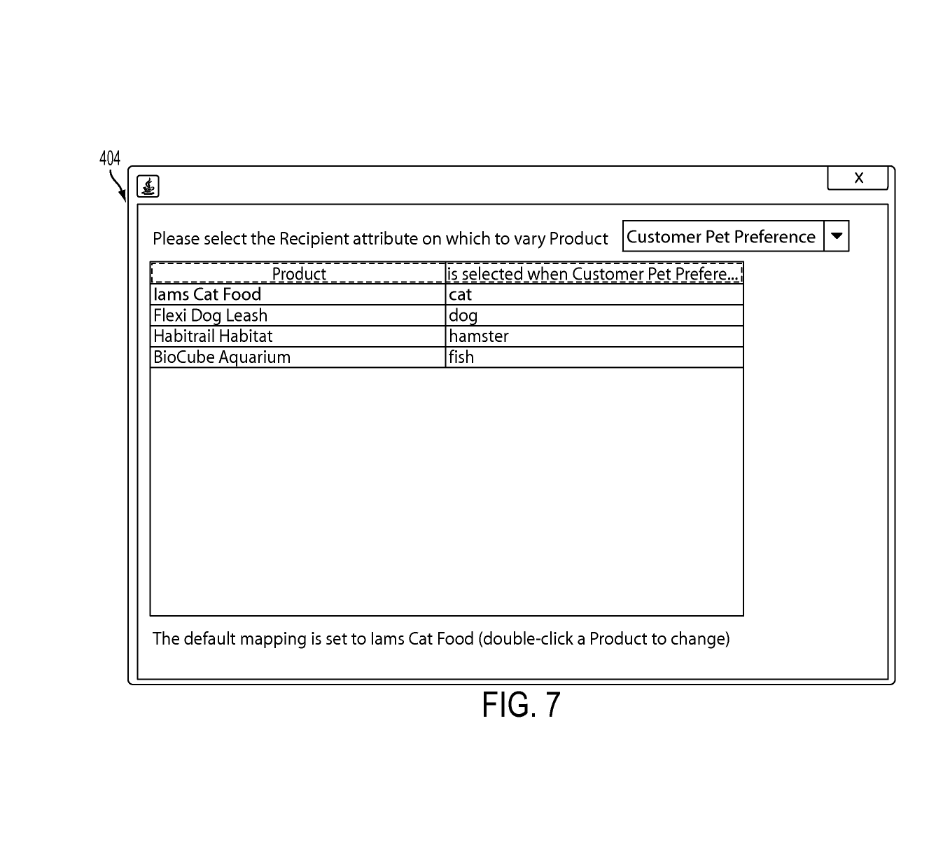

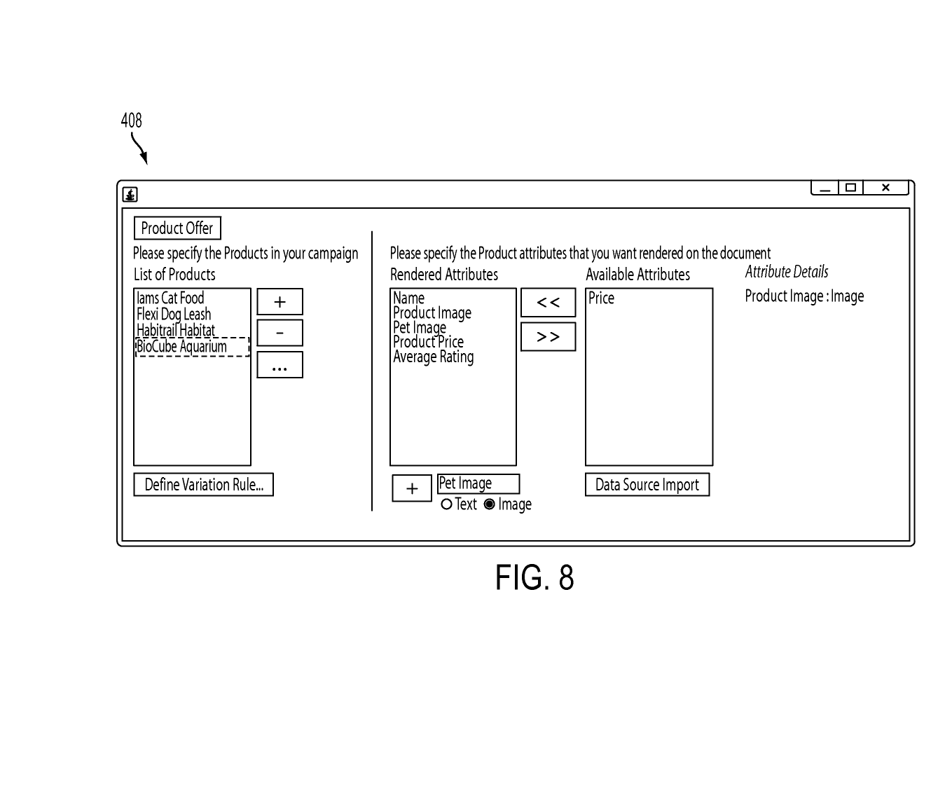

In FIG. 6, a screenshot 400 of an exemplary VDP creation wizard is illustrated. The semantic contents of the data source (e.g., Table 2) are made available to the user to render on the document in the manner previously described. The user selects to render the semantic element of “First Name”. The method described herein can first verify that a Recipient data source has been provided and that the campaign intent specified passes all validation tests. If so, the needed components are then gathered and packaged for generating a proof set on the variable-data production server. The resulting proof set is then displayed to the user for the rendered attribute “Recipient First Name”. In FIG. 7, which is another screenshot 404 of the VDP creation wizard, the user semantically specifies a recipient attribute on which to vary the Product offered to the Recipient based on the Recipient's Pet Preference. As shown in screenshot 408 of FIG. 8, the user then selects the information about the offered Product that they want rendered on the document.

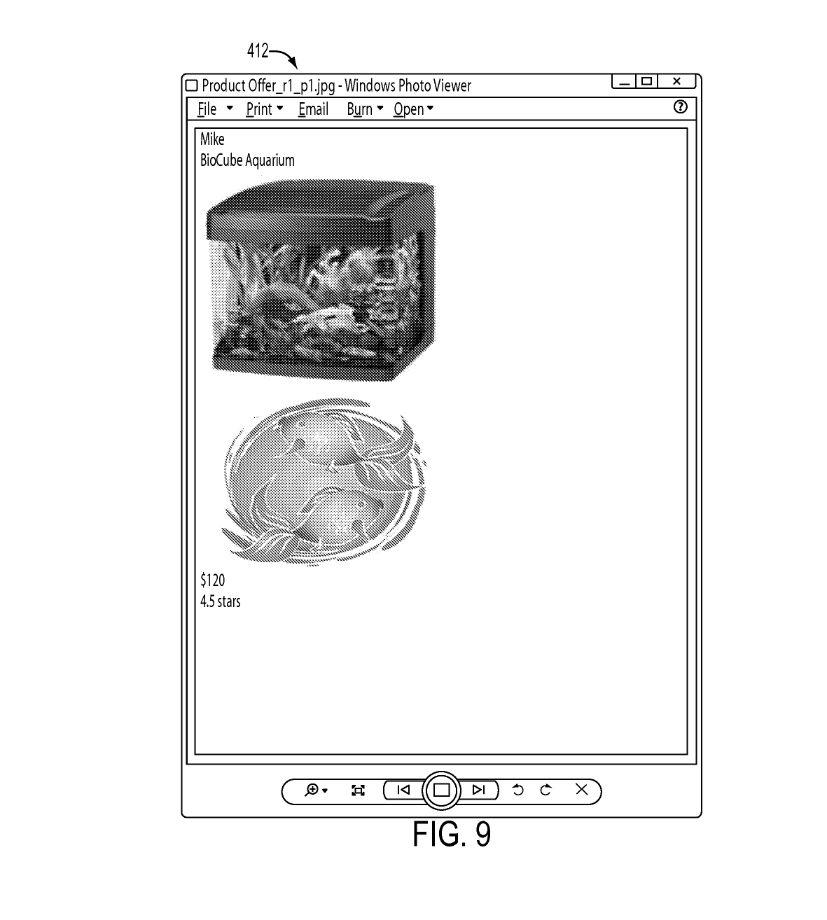

Turning to FIG. 9, once the campaign specification is consistent and valid, the method described herein is employed once again to refresh the visual presented to the user. In screenshot 412, the additional elements related to the offered Product are now displayed in addition to the Recipient's First Name which had been previously rendered. The user can then continue to add more logic to display a variable “Discount” and a static “Call To Action”. The user can then choose to show the annotations for all the variable content.

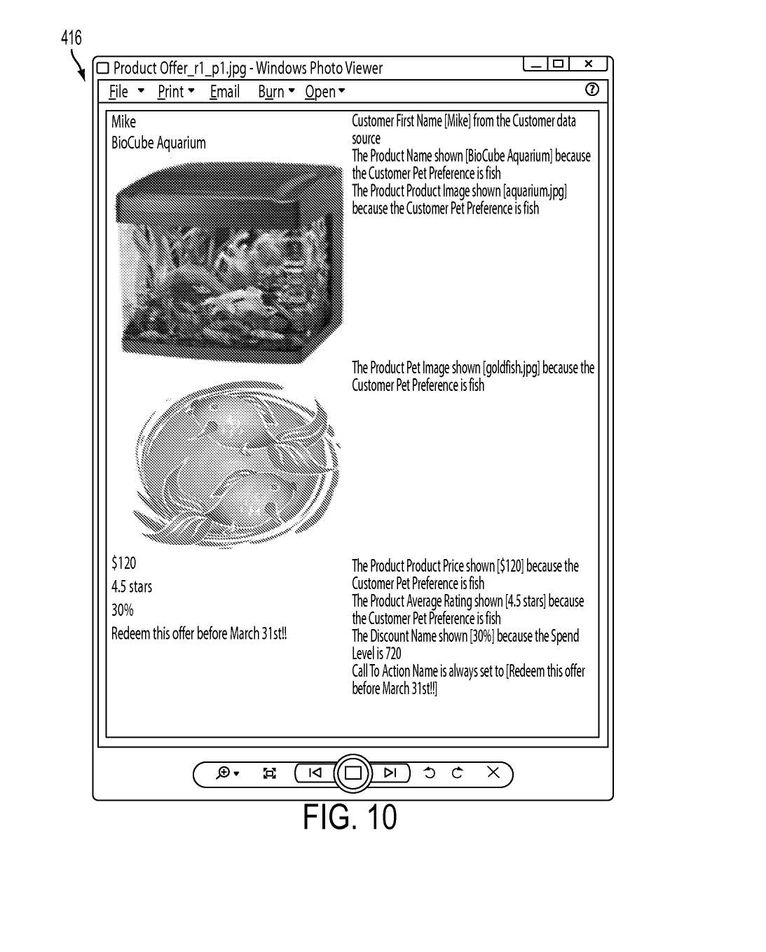

In the example screenshot 416 shown in FIG. 10, the annotations are laid out in the right column of the dynamic document alongside the variable content intended for the campaign Recipients shown in the left column. The annotations provide a plain language description of the logic leading to the presentation of the various components of the campaign. As will be appreciated, the annotations enable an unsophisticated user to comprehend and/or verify the logic.

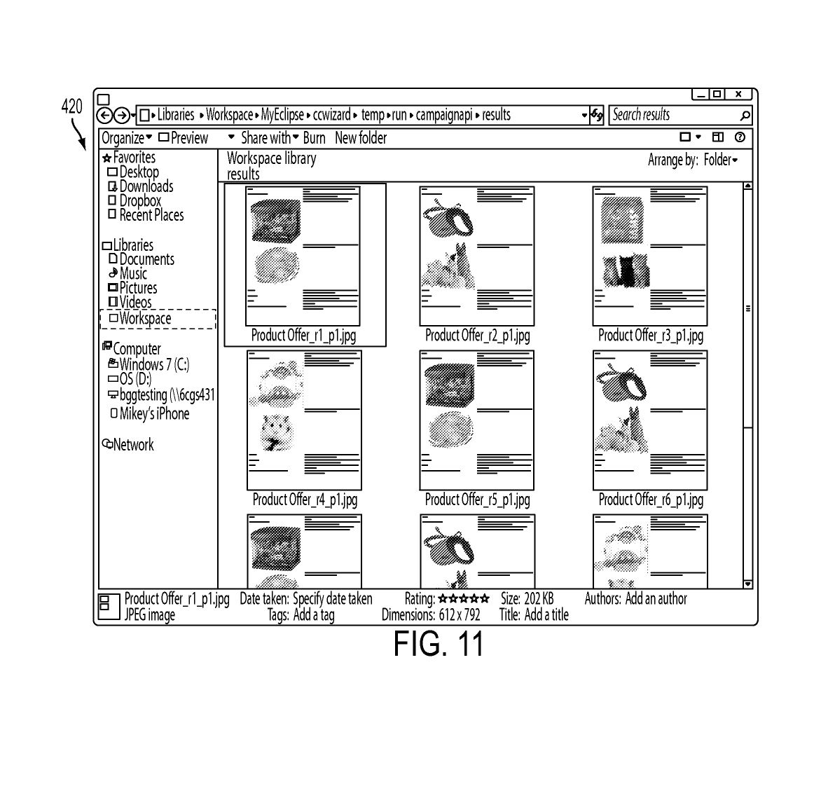

With reference to FIG. 11, a screen shot 420 is shown of a full set of auto-generated, annotated dynamic documents in accordance with the present disclosure. Throughout the whole campaign creation process, the user can view all and/or scroll through the resulting documents to test for validation of their campaign intent and for any logic errors that may have been inadvertently introduced.

As will now be appreciated, aspects of the present disclosure can provide real-time feedback throughout campaign creation whereby the user can visualize and easily validate the business rules in a variable-data campaign. Aspects of the disclosure can be implemented throughout the campaign creation process (e.g., FIG. 1), and/or after the step 26 of the method shown and described in connection with FIG. 1. In addition, a means for auto-generated annotations describing the variable contents in dynamic documents is provided. The present disclosure also enables communication of semantically robust campaign intent to variable-data campaign graphic designers and variable-data logic developers. The present disclosure can accelerate and ease the creation of variable-data marketing campaigns by the user without variable-data logic programming expertise or graphic designer expertise (such as a small-medium business owner or market service provider), and ease communication and collaboration with clients of personalized marketing campaigns and a variable-data design team.

As used herein, the term dynamic content object includes any object, data, etc. that forms a part of the VDP campaign. In one example, a dynamic content object include product information such as an image or price of a product. In another example, a dynamic content object includes recipient information such as mailing address, name, etc.

It should further be appreciated that the term “natural language sentence” includes sentences such as those set forth in paragraph [0046]. The term “natural language description” includes plain language statements of the logic used to develop the VDP campaign (as opposed to e.g., logical expressions), and can include phrases such as those shown in the right-hand column of FIG. 10.

The exemplary embodiments have been described with reference to the preferred embodiments. Obviously, modifications and alterations will occur to others upon reading and understanding the preceding detailed description. It is intended that the exemplary embodiments be construed as including all such modifications and alterations insofar as they come within the scope of the appended claims or the equivalents thereof.

1. A computer-implemented method for personalizing a variable data publishing (VDP) marketing campaign pattern, comprising:
receiving user input related to an intended campaign purpose from a non-expert user;
automatically selecting a VDP pattern from a plurality of a pre-generated VDP patterns as a function of the intended campaign purpose;
retrieving product information to be presented on campaign documents for distribution to a plurality of recipients;
receiving recipient information to appear on the campaign documents;
prompting the user, as a function of the intended campaign purpose, to specify personalization parameters for personalizing the campaign documents;
receiving user-specified personalization parameter information;
outputting a personalized VDP pattern instance for use in generating the campaign documents;
displaying a representative illustration of at least one campaign document including at least one dynamic content object based on at least one of the product information and recipient information; and
displaying a natural language description of the at least one dynamic content object.

2. The method according to claim 1, wherein receiving user input related to an intended campaign purpose comprises presenting the user with a plurality of natural language sentences each describing a different campaign purpose, and receiving an indication from the user regarding a selected natural language sentence.

3. The method according to claim 2, wherein the displaying a natural language description of the at least one dynamic content object includes displaying at least a portion of a selected natural language sentence.

4. The method according to claim 2, further comprising displaying a plurality of natural language descriptions.

5. The method according to claim 1, further comprising presenting the user with at least one VDP element comprising a natural language sentence having a plurality of selectable element parameters.

6. The method according to claim 5, further comprising receiving an indication that the user has selected at least one of the selectable element parameters.

7. The method according to claim 5, wherein the selectable element parameters comprise one or more of:
a personalized product to be offered to the recipient;
a personalized reward to be offered to the recipient;
a restriction placed on a personalized offer made to the recipient; and
a personalized call to action to be performed by the recipient.

8. The method according to claim 1, wherein the recipient information comprises:
a first name of each recipient;
a last name of each recipient;
an address of each recipient; and
an amount of money spent by each recipient in a given time period for one or more products sold by the user.

9. A processor configured to execute computer-executable instructions for performing the method of claim 1, the instructions being stored on a computer-readable medium.

10. A system that facilitates personalizing a variable data publishing (VDP) marketing campaign pattern, comprising:
a graphical user interface (GUI) via which a user interacts with a campaign creation application that is persistently stored on a computer-readable medium; and
a processor that executes the campaign creation application and is configured to:
receive user input related to an intended campaign purpose from a non-expert user;
automatically select a VDP pattern from a plurality of a pre-generated VDP pattern as a function of the intended campaign purpose;
retrieve product information to be presented on campaign documents for distribution to a plurality of recipients, the product information being retrieved from a product data source provided by the user;
receive recipient information to appear on the campaign documents, the recipient information being provided in a recipient data source provided by the user;
prompt the user, as a function of the intended campaign purpose, to specify personalization parameters for personalizing the campaign documents;
receive user-specified personalization parameter information; and
output a personalized VDP pattern instance for use in generating the campaign documents;
display a representative illustration of at least one campaign document including at least one dynamic content object based on at least one of the product information and recipient information; and
display a natural language description of the at least one dynamic content object.

11. The system according to claim 10, wherein the user input related to an intended campaign purpose comprises an indication that is received via the GUI from the user regarding a user-selected natural language sentence describing the intended campaign purpose.

12. The system according to claim 11, wherein the displaying a natural language description of the at least one dynamic content object includes displaying at least a portion of a user-selected natural language sentence.

13. The system according to claim 12, further comprising displaying a plurality of user-selected natural language sentences.

14. The system according to claim 11, wherein the processor is further configured to present the user with at least one VDP element comprising a natural language sentence having a plurality of selectable element parameters.

15. The system according to claim 14, wherein the processor is further configured to receive an indication that the user has selected at least one of the selectable element parameters.

16. The system according to claim 11, wherein the recipient data source is an electronic spreadsheet document that comprises information regarding customers of the user.

17. A computer-readable medium having persistently stored thereon computer-executable instructions for personalizing a variable data publishing (VDP) marketing campaign pattern, comprising instructions for:
receiving user input related to an intended campaign purpose from a non-expert user;
automatically selecting a VDP pattern from a plurality of a pre-generated VDP patterns as a function of the intended campaign purpose;
retrieving product information to be presented on campaign documents for distribution to a plurality of recipients;
receiving recipient information to appear on the campaign documents;
prompting the user, as a function of the intended campaign purpose, to specify personalization parameters for personalizing the campaign documents;
receiving user-specified personalization parameter information;
outputting a personalized VDP pattern instance for use in generating the campaign documents;
displaying a representative illustration of at least one campaign document including at least one dynamic content object based on at least one of the product information and recipient information; and
displaying a natural language description of the at east one dynamic content object.

18. A computer readable medium according to claim 17, wherein the displaying a natural language description of the at least one dynamic content object includes displaying at least one specified personalization parameter adjacent the at least one dynamic content object.
